(19) United States
(12) Patent Application Publication
(10) Pub. No.: US 2026/0142591 A1
(43) Pub. Date: May 21, 2026

(54) POWER MODULE MANUFACTURING METHOD TO MITIGATE VOLTAGE OVERSHOOT

(71) Applicant: GM Global Technology Operations LLC, Detroit, MI (US)

(72) Inventors: Yilun Luo, Ann Arbor, MI (US); Mohammad N. Anwar, Northville, MI (US); Khorshed Mohammed Alam, Canton, MI (US); Sanjeev M. Naik, Troy, MI (US); Luciano N. Di Perna, Rochester Hills, MI (US); Odavia Schneider, Walled Lake, MI (US)

(21) Appl. No.: 18/953,727

(22) Filed: Nov. 20, 2024

(51) Int. Cl. H02M 7/537; B60L 50/51; B60R 16/023; H02M 7/00

(52) U.S. Cl. CPC H02M 7/537; B60L 50/51; B60R 16/0231; H02M 7/003; B60L 2210/40

(57) ABSTRACT

A power inverter may include a plurality of direct current (DC) bus bars. Each of the plurality of DC bus bars has a terminal end and a die attachment region. The power inverter further may include a plurality of power switch dies. Each of the plurality of power switch dies is affixed to the die attachment region at one of a plurality of die locations. The one of the plurality of die locations for each of the plurality of power switch dies is selected to minimize a drain-source voltage overshoot of each of the plurality of power switch dies during switching.

### INTRODUCTION

The present disclosure relates to methods for manufacturing systems and apparatuses for power conversion.

To convert power in vehicle applications, power modules may be utilized. Power modules are self-contained power-electronic devices typically including semiconductor switches configured to be controllable to accomplish power conversion tasks such as, for example, direct current (DC) to alternating current (AC) conversion, AC to DC conversion, DC to DC conversion, and/or the like. In some examples, power modules are configured as a half-bridge with four semiconductor devices, allowing for DC to AC conversion. Multiple power modules may be used in tandem to provide multi-phase AC power to a load such as, for example, a traction motor of a vehicle.

While current methods for manufacturing power conversion devices achieve their intended purpose, there is a need for a new and improved method for manufacturing power modules for power inverters to mitigate voltage overshoot.

### SUMMARY

According to several aspects, a power inverter may include a plurality of direct current (DC) bus bars. Each of the plurality of DC bus bars has a terminal end and a die attachment region. The power inverter further may include a plurality of power switch dies. Each of the plurality of power switch dies is affixed to the die attachment region at one of a plurality of die locations. The one of the plurality of die locations for each of the plurality of power switch dies is selected to minimize a drain-source voltage overshoot of each of the plurality of power switch dies during switching.

In another aspect of the present disclosure, the one of the plurality of die locations for each of the plurality of power switch dies is selected based at least in part on a parasitic inductance of each of the plurality of die locations. The parasitic inductance of each of the plurality of die locations is a parasitic inductance between each of the plurality of die locations and the terminal end of one of the plurality of DC bus bars.

In another aspect of the present disclosure, the parasitic inductance of each of the plurality of die locations varies directly with a bus bar length between each of the plurality of die locations and the terminal end.

In another aspect of the present disclosure, the one of the plurality of die locations for each of the plurality of power switch dies is selected based at least in part on a threshold voltage of each of the plurality of power switch dies.

In another aspect of the present disclosure, a first power switch die of the plurality of power switch dies is affixed at a first die location of the plurality of die locations. The first power switch die has a first threshold voltage and the first die location has a first parasitic inductance. A second power switch die of the plurality of power switch dies is affixed at a second die location of the plurality of die locations. The second power switch die has a second threshold voltage and the second die location has a second parasitic inductance. The second threshold voltage is greater than the first threshold voltage and the second parasitic inductance is greater than the first parasitic inductance.

In another aspect of the present disclosure, the plurality of DC bus bars includes a positive DC bus bar. The positive DC bus bar has a positive terminal end and a positive die attachment region. The plurality of DC bus bars further includes a negative DC bus bar. The negative DC bus bar has a negative terminal end and a negative die attachment region. The plurality of power switch dies includes a plurality of high-side power switch dies. Each of the plurality of high-side power switch dies is affixed to the positive die attachment region of the positive DC bus bar at one of a plurality of high-side die locations. The plurality of power switch dies further includes a plurality of low-side power switch dies. Each of the plurality of low-side power switch dies is affixed to negative die attachment region of the negative DC bus bar at one of a plurality of low-side die locations.

In another aspect of the present disclosure, the second die location is one of the plurality of high-side die locations.

In another aspect of the present disclosure, the one of the plurality of die locations for each of the plurality of power switch dies is selected based at least in part on a material type of each of the plurality of power switch dies.

In another aspect of the present disclosure, a third power switch die of the plurality of power switch dies is affixed at a first die location of the plurality of die locations. The third power switch die has a first material type and the first die location has a first parasitic inductance. A fourth power switch die of the plurality of power switch dies is affixed at a second die location of the plurality of die locations. The fourth power switch die has a second material type and the second die location has a second parasitic inductance. The second parasitic inductance is greater than the first parasitic inductance.

In another aspect of the present disclosure, the first material type is silicon carbide and the second material type is silicon.

According to several aspects, a method for manufacturing a power inverter is provided. The method may include affixing a plurality of direct current (DC) bus bars to a dielectric substrate. Each of the plurality of DC bus bars has a terminal end and a die attachment region. The method further may include affixing a plurality of power switch dies to the plurality of DC bus bars. Each of the plurality of power switch dies is affixed to the die attachment region at one of a plurality of die locations. The one of the plurality of die locations for each of the plurality of power switch dies is selected to minimize a drain-source voltage overshoot of each of the plurality of power switch dies during switching.

In another aspect of the present disclosure, affixing the plurality of power switch dies further may include selecting the one of the plurality of die locations for each of the plurality of power switch dies based at least in part on a parasitic inductance of each of the plurality of die locations. The parasitic inductance of each of the plurality of die locations is a parasitic inductance between each of the plurality of die locations and the terminal end of one of the plurality of DC bus bars.

In another aspect of the present disclosure, selecting the one of the plurality of die locations for each of the plurality of power switch dies further may include selecting the one of the plurality of die locations for each of the plurality of power switch dies based at least in part on a threshold voltage of each of the plurality of power switch dies.

In another aspect of the present disclosure, affixing the plurality of power switch dies further may include affixing a first power switch die of the plurality of power switch dies at a first die location of the plurality of die locations. The first power switch die has a first threshold voltage and the first die location has a first parasitic inductance. Affixing the plurality of power switch dies further may include affixing a second power switch die of the plurality of power switch dies at a second die location of the plurality of die locations. The second power switch die has a second threshold voltage and the second die location has a second parasitic inductance. The second threshold voltage is greater than the first threshold voltage and the second parasitic inductance is greater than the first parasitic inductance.

In another aspect of the present disclosure, affixing the plurality of DC bus bars further may include affixing a positive DC bus bar to the dielectric substrate. The positive DC bus bar has a positive terminal end and a positive die attachment region. The positive terminal end is in electrical communication with a DC positive terminal. Affixing the plurality of DC bus bars further may include affixing the plurality of power switch dies further may include affixing a plurality of high-side power switch dies to the positive die attachment region of the positive DC bus bar at one of a plurality of high-side die locations. The second die location is one of the plurality of high-side die locations.

In another aspect of the present disclosure, selecting the one of the plurality of die locations for each of the plurality of power switch dies further may include selecting the one of the plurality of die locations for each of the plurality of power switch dies based at least in part on a material type of each of the plurality of power switch dies.

In another aspect of the present disclosure, affixing the plurality of power switch dies further may include affixing a third power switch die of the plurality of power switch dies at a first die location of the plurality of die locations. The third power switch die has a silicon carbide material type and the first die location has a first parasitic inductance. Affixing the plurality of power switch dies further may include affixing a fourth power switch die of the plurality of power switch dies at a second die location of the plurality of die locations. The fourth power switch die has a silicon material type and the second die location has a second parasitic inductance. The second parasitic inductance is greater than the first parasitic inductance.

According to several aspects, a power inverter for a vehicle is provided. The power inverter may include a plurality of direct current (DC) bus bars. Each of the plurality of DC bus bars has a terminal end and a die attachment region. The power inverter further may include a plurality of power switch dies. Each of the plurality of power switch dies is affixed to the die attachment region at one of a plurality of die locations. The one of the plurality of die locations for each of the plurality of power switch dies is selected to minimize a drain-source voltage overshoot of each of the plurality of power switch dies during switching. The one of the plurality of die locations for each of the plurality of power switch dies is selected based at least in part on a parasitic inductance of each of the plurality of die locations. The parasitic inductance of each of the plurality of die locations is a parasitic inductance between each of the plurality of die locations and the terminal end of one of the plurality of DC bus bars.

In another aspect of the present disclosure, a first power switch die of the plurality of power switch dies is affixed at a first die location of the plurality of die locations. The first power switch die has a first threshold voltage and the first die location has a first parasitic inductance. A second power switch die of the plurality of power switch dies is affixed at a second die location of the plurality of die locations. The second power switch die has a second threshold voltage and the second die location has a second parasitic inductance. The second threshold voltage is greater than the first threshold voltage and the second parasitic inductance is greater than the first parasitic inductance.

In another aspect of the present disclosure, a third power switch die of the plurality of power switch dies is affixed at a first die location of the plurality of die locations. The third power switch die has a first material type and the first die location has a first parasitic inductance. A fourth power switch die of the plurality of power switch dies is affixed at a second die location of the plurality of die locations. The fourth power switch die has a second material type and the second die location has a second parasitic inductance. The second parasitic inductance is greater than the first parasitic inductance.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a power system for a vehicle, according to an exemplary embodiment;

FIG. 2 is a schematic diagram of a power inverter of the power system, according to an exemplary embodiment;

FIG. 3A is a schematic diagram of a first power module of the power inverter, according to an exemplary embodiment;

FIG. 3B is a schematic diagram of a second power module of the power inverter, according to an exemplary embodiment; and

FIG. 4 is a flowchart of a method for manufacturing the power inverter, according to an exemplary embodiment.

### DETAILED DESCRIPTION

The following description is merely exemplary in nature and is not intended to limit the present disclosure, application, or uses.

In aspects of the present disclosure, when manufacturing power electronic devices such as, for example, power inverters for vehicles, it is advantageous to utilize components with known electrical characteristics within acceptable ranges. However, due to manufacturing variation, electrical characteristics within component batches may vary. The present disclosure provides a new and improved method for manufacturing power inverters for vehicles allowing for the utilization of components with varying electrical characteristics to minimize voltage overshoot.

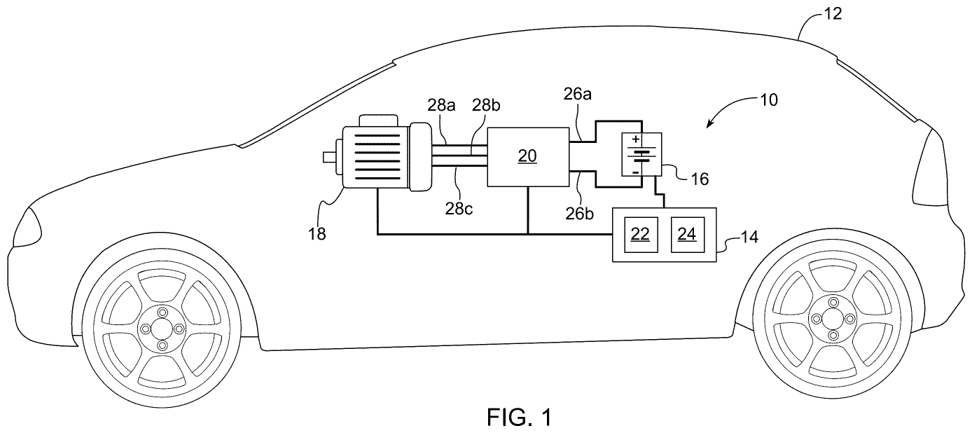

Referring to FIG. 1, a power system for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, a rechargeable energy storage system (RESS) 16, a traction motor 18, and a power inverter 20.

The controller 14 is used to control the RESS 16, the traction motor 18, and the power inverter 20. The controller 14 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other.

The controller 14 is in electrical communication with the RESS 16, the traction motor 18, and the power inverter 20. The controller 14 may also be inter-connected with additional systems and/or controllers of the vehicle 12, allowing the controller 14 to access data such as, for example, speed, acceleration, braking, and steering angle of the vehicle 12. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The RESS 16 stores and provides electrical energy in the form of direct current (DC) energy for propulsion of the vehicle 12. In an exemplary embodiment, the RESS 16 includes a plurality of battery cells (e.g., lithium-ion battery cells) electrically connected in series and/or parallel to provide an increased voltage and/or current-carrying capacity. In a non-limiting example, the plurality of battery cells are housed in an enclosure configured to protect the plurality of battery cells from mechanical vibration, water intrusion, and dust intrusion. The enclosure is also configured to provide temperature regulation (e.g., using a liquid cooling system, a resistive heating system, and/or the like).

In an exemplary embodiment, the RESS 16 further includes a battery management system (BMS) in electrical communication with the controller 14 configured to monitor battery characteristics such as a state of charge (SOC), state of health (SOH), temperature, and/or the like, and transmit the battery characteristics to the controller 14. In a non-limiting example, the BMS includes a BMS controller in electrical communication with a plurality of BMS sensors disposed within the enclosure of the RESS 16. In another non-limiting example, the BMS further includes one or more electronic switches (e.g., relays, contactors, semiconductor-based switches, and/or the like) which are operable to interrupt current flow through the plurality of battery cells of the RESS 16 in response to commands received from the BMS controller and/or the controller 14. In an exemplary embodiment, the RESS 16 provides a DC voltage across a positive and negative output terminal. The positive and negative output terminals are electrically connected to the power inverter 20 as will be discussed in greater detail below.

The traction motor 18 is used to convert electrical energy from the RESS 16 to mechanical energy (i.e., rotational energy) to propel the vehicle 12. In an exemplary embodiment, the traction motor 18 is a three-phase alternating current (AC) induction motor capable of converting AC energy to mechanical energy. In a non-limiting example, the traction motor 18 includes a stator having a plurality of stator windings and a rotor disposed rotatably within the stator having a plurality of rotor windings. The stator windings are excited by three-phase AC provided by the power inverter 20 to produce a rotating stator magnetic field. The rotating stator magnetic field induces currents in the rotor windings, which in turn produces a rotor magnetic field which interacts with the rotating stator magnetic field causing the rotor to rotate. The amplitude, frequency, and/or relative phase shift of the excitation of each of the three phases of the stator windings controls speed, direction, and/or torque of the traction motor 18. The controller 14 is in electrical communication with the traction motor 18 for monitoring and/or control of the traction motor 18, for example, to measure a temperature, rotational speed, and/or the like of the traction motor 18.

The power inverter 20 is used to convert the direct current (DC) energy provided by the RESS 16 to three-phase alternating current (AC) energy for use by the traction motor 18. In an exemplary embodiment, the power inverter 20 includes a plurality of power semiconductor devices, such as, for example, insulated-gate bipolar transistors (IGBTs), metal-oxide semiconductor field-effect transistors (MOSFETs), and/or the like configured to convert DC to three-phase AC. In a non-limiting example, the power inverter 20 functions by switching the plurality of power semiconductor devices in a pattern to generate an AC sinusoidal output for each of the three phases. The pattern may be adjusted to vary an amplitude, frequency, and/or relative phase shift of each of the three phases in order to control speed, direction, and/or torque of the traction motor 18 based on signals from the controller 14. The power inverter 20 includes a DC positive terminal 26a and a DC negative terminal 26b electrically connected to the RESS 16. The power inverter 20 further includes a first AC terminal 28a, a second AC terminal 28b, and a third AC terminal 28c electrically connected to the traction motor 18. The power inverter 20 is in electrical communication with the controller 14, such that the controller 14 may enable, disable, and otherwise adjust the operation of the power inverter 20. It should be understood that various types of inverters, including, for example, multi-level inverters, are within the scope of the present disclosure.

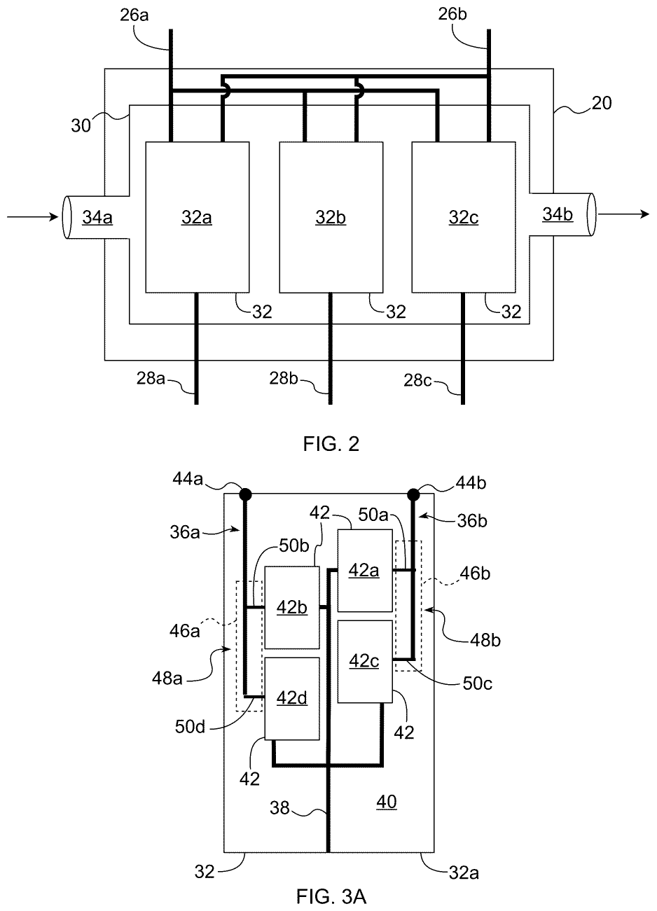

Referring to FIG. 2, a schematic diagram of the power inverter 20 is shown. In an exemplary embodiment, the power inverter 20 includes a heatsink 30 and a plurality of power modules 32.

The heatsink 30 is used to transfer heat away from the plurality of power modules 32 during operation of the power inverter 20. In an exemplary embodiment, the heatsink 30 includes a cooling plate with one or more internal liquid-tight channels for transferring coolant through the heatsink 30. The heatsink 30 further includes a coolant inlet 34a where coolant enters the heatsink 30 and a coolant outlet 34b where coolant exits the heatsink 30. In a non-limiting example, after exiting the heatsink 30 through the coolant outlet 34b, the coolant flows through a radiator to release heat absorbed from the plurality of power modules 32.

The plurality of power modules 32 are self-contained modules for converting DC power to AC power. In a non-limiting example, shown in FIG. 2, the power inverter 20 includes a first power module 32a, a second power module 32b, and a third power module 32c. It should be understood that the power inverter 20 may include any number of power modules without departing from the scope of the present disclosure. In an exemplary embodiment, the plurality of power modules 32 are affixed to the heatsink 30 using, for example, a thermal compound, a thermal adhesive, and/or the like.

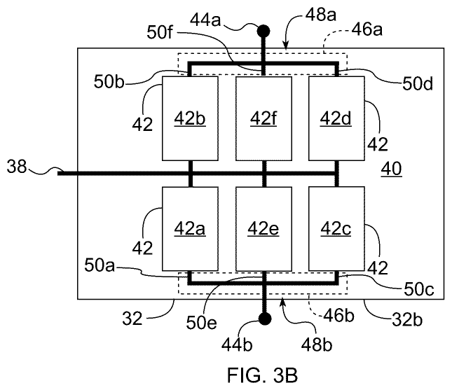

Referring to FIG. 3A, a schematic diagram of the first power module 32a is shown. It should be understood that the following disclosure is also applicable to any number of additional power modules of the power inverter 20, including, for example, the second power module 32b and the third power module 32c. In an exemplary embodiment, the first power module 32a includes a positive DC bus bar 36a, a negative DC bus bar 36b, an AC bus bar 38 affixed to a dielectric substrate 40 (e.g., a direct bonded copper substrate) and a plurality of power switch dies 42.

The positive DC bus bar 36a includes a positive terminal end 44a and a positive die attachment region 46a. The positive terminal end 44a is electrically connected to the DC positive terminal 26a. The positive die attachment region 46a is used for electrical connection of a plurality of high-side power switch dies (discussed below) at a plurality of high-side die locations 48a via a current-carrying terminal (e.g., a drain or source terminal) of each of the plurality of high-side power switch dies.

The negative DC bus bar 36b includes a negative terminal end 44b and a negative die attachment region 46b. The negative terminal end 44b is electrically connected to the DC negative terminal 26b. The negative die attachment region 46b is used for electrical connection of a plurality of low-side power switch dies (discussed below) at a plurality of low-side die locations 48b via a current-carrying terminal (e.g., a drain or source terminal) of each of the plurality of low-side power switch dies.

The positive terminal end 44a and the negative terminal end 44b are also collectively referred to herein as terminal ends. The positive die attachment region 46a and the negative die attachment region 46b are also collectively referred to herein as die attachment regions. The plurality of high-side die locations 48a and the plurality of low-side die locations 48b are also collectively referred to herein as a plurality of die locations. The positive DC bus bar 36a and the negative DC bus bar 36b are also collectively referred to herein as a plurality of DC bus bars.

The AC bus bar 38 electrically connects a current-carrying terminal (e.g., a drain or source terminal) of each of the plurality of power switch dies 42 to the first AC terminal 28a. The plurality of power switch dies 42 includes a first power switch die 42a, a second power switch die 42b, a third power switch die 42c, and a fourth power switch die 42d. It should be understood that each of the plurality of power modules 32 may include any number of power switch dies.

Each of the plurality of power switch dies 42 includes one or more semiconductor devices such as, for example, transistors, thyristors, triacs, GTOs (gate turn-off thyristors), IGBTs (insulated gate bipolar transistors), MOSFETs (metal-oxide-semiconductor field-effect transistors), SCRs (silicon-controlled rectifiers), and/or the like. The first power switch die 42a is connected to the DC negative terminal 26b at a first die location 50a in the negative die attachment region 46b. The second power switch die 42b is connected to the DC positive terminal 26a at a second die location 50b in the positive die attachment region 46a.

The third power switch die 42c is connected to the DC negative terminal 26b at a third die location 50c in the negative die attachment region 46b. The fourth power switch die 42d is connected to the DC positive terminal 26a at a fourth die location 50d in the positive die attachment region 46a. The second power switch die 42b and the fourth power switch die 42d are connected to the DC positive terminal 26a and thus are referred to as the plurality of high-side power switch dies. The first power switch die 42a and the third power switch die 42c are connected to the DC negative terminal 26b and thus are referred to as the plurality of low-side power switch dies.

In an exemplary embodiment, each of the plurality of power switch dies 42 is characterized by a plurality of electrical characteristics. In a non-limiting example, the plurality of electrical characteristics includes at least: a threshold voltage and a material type. The threshold voltage is a minimum gate-to-source voltage required to create a conductive channel between the source and drain terminals. The material type is the semiconductor material used to create the power switch die, such as, for example, silicon (Si), gallium arsenide (GaAs), silicon carbide (SiC), gallium nitride (GaN), and/or the like.

In the scope of the present disclosure, drain-source voltage overshoot is defined as a transient spike in voltage between the drain and source terminals that exceeds the nominal operating voltage of the power switch die. Drain-source voltage overshoot can lead to device degradation or failure over time.

Both the threshold voltage and the material type influence a drain-source voltage overshoot of the power switch die. In a non-limiting example, a lower threshold voltage allows the power switch die to switch on with less gate drive voltage, leading to faster switching times. Furthermore, wide bandgap materials like silicon carbide (SiC) and gallium nitride (GaN) can handle higher voltages and faster switching speeds compared to silicon (Si). However, faster switching can increase the likelihood of overshoot due to higher rates of change in voltage and current, which induce voltage spikes in inductive elements or parasitic inductances.

Furthermore, the electrical design and topology of the plurality of power modules 32, including the arrangement of the plurality of power switch dies 42 also influences the drain-source voltage overshoot of the plurality of power switch dies 42. In a non-limiting example, the parasitic inductance between each of the plurality of die locations and the terminal end of one of the plurality of DC bus bars influences the drain-source voltage overshoot of the plurality of power switch dies 42. Larger parasitic inductances tend to increase the likelihood and severity of drain-source voltage overshoot.

In a non-limiting example, the plurality of power switch dies 42 are provided in bulk for the manufacturing process of the plurality of power modules 32. Therefore, the electrical characteristics of the plurality of power switch dies 42 may vary.

To ensure proper operation of the plurality of power modules 32 of the power inverter 20, predetermined thresholds are defined. In an exemplary embodiment, a predetermined voltage overshoot threshold is defined as a maximum allowable drain-source voltage overshoot for any individual power switch die. The present disclosure provides a new and improved method for manufacturing the plurality of power modules 32 to minimize the drain-source voltage overshoot of each of the plurality of power switch dies 42 during switching.

Referring to FIG. 3B, a schematic diagram of the second power module 32b is shown. It should be understood that the following disclosure is also applicable to any number of additional power modules of the power inverter 20, including, for example, the first power module 32a and the third power module 32c. The disclosure provided above in reference to the first power module 32a and FIG. 3A also applies to the second power module 32b and FIG. 3B. In the exemplary embodiment of FIG. 3B, the plurality of DC bus bars, the AC bus bar 38, and the plurality of power switch dies 42 are arranged horizontally rather than vertically as in FIG. 3A. It should be understood that the arrangements of the plurality of DC bus bars, the AC bus bar 38, and the plurality of power switch dies 42 shown in FIGS. 3A and 3B is merely exemplary in nature, and that any arrangement or orientation of the plurality of DC bus bars, the AC bus bar 38, and the plurality of power switch dies 42 is within the scope of the present disclosure.

Furthermore, the exemplary embodiment of FIG. 3B includes a fifth power switch die 42e and a sixth power switch die 42f. The fifth power switch die 42e is connected to the DC negative terminal 26b at a fifth die location 50e in the negative die attachment region 46b. The sixth power switch die 42f is connected to the DC positive terminal 26a at a sixth die location 50f in the positive die attachment region 46a. The second power switch die 42b, the fourth power switch die 42d, and the sixth power switch die 42f are connected to the DC positive terminal 26a and thus are referred to as the plurality of high-side power switch dies. The first power switch die 42a, the third power switch die 42c, and the fifth power switch die 42e are connected to the DC negative terminal 26b and thus are referred to as the plurality of low-side power switch dies. It should be understood that that any arrangement, orientation, and quantity of the plurality of DC bus bars, the AC bus bar 38, and the plurality of power switch dies 42 is within the scope of the present disclosure.

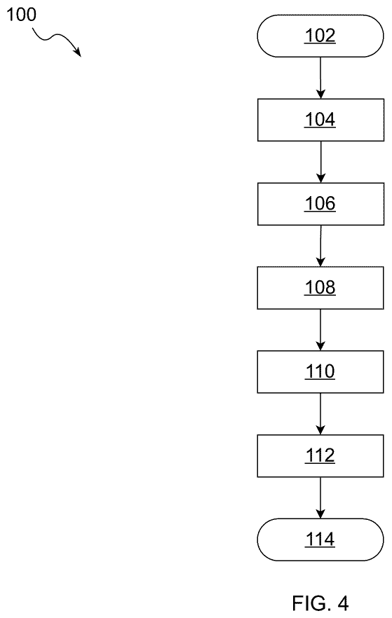

Referring to FIG. 4, a flowchart of a method 100 for manufacturing a power inverter is shown. The method 100 begins at block 102 and proceeds to block 104. At block 104, the plurality of DC bus bars (i.e., the positive DC bus bar 36a and the negative DC bus bar 36b) and the AC bus bar 38 are affixed to the dielectric substrate 40. After block 104, the method 100 proceeds to block 106.

At block 106, a parasitic inductance of each of the plurality of die locations (i.e., the plurality of high-side die locations 48a and the plurality of low-side die locations 48b) is determined. In another exemplary embodiment, an intrinsic parasitic inductance of each of the plurality of power switch dies 42 is determined. In the scope of the present disclosure, the parasitic inductance of each of the plurality of die locations is a parasitic inductance between each of the plurality of die locations and the terminal end of one of the plurality of DC bus bars. For example, the parasitic inductance of one of the plurality of high-side die locations 48a is measured between the one of the plurality of high-side die locations 48a and the positive terminal end 44a. The parasitic inductance of one of the plurality of low-side die locations 48b is measured between the one of the plurality of low-side die locations 48b and the negative terminal end 44b. In the scope of the present disclosure, the intrinsic parasitic inductance of each of the plurality of power switch dies 42 is influenced by the material characteristics and manufacturing process of each of the plurality of power switch dies 42.

In a non-limiting example, the parasitic inductance of each of the plurality of die locations varies directly with a bus bar length between each of the plurality of die locations and the terminal end. Therefore, a longer bus bar length results in a greater parasitic inductance. In an exemplary embodiment, the parasitic inductance of each of the plurality of die locations is determined based at least in part on the bus bar length. In a non-limiting example, the parasitic inductance of the first die location 50a is determined based at least in part on a first bus bar length between the first die location 50a and the negative terminal end 44b. The parasitic inductance of the second die location 50b is determined based at least in part on a second bus bar length between the second die location 50b and the positive terminal end 44a.

In the example shown in FIG. 3A, because the first bus bar length between the first die location 50a and the negative terminal end 44b is less than the second bus bar length between the second die location 50b and the positive terminal end 44a, the parasitic inductance of the second die location 50b is greater than the parasitic inductance of the first die location 50a. In the example shown in FIG. 3B, because a fifth bus bar length between the fifth die location 50e and the negative terminal end 44b is less than both the first bus bar length and a third bus bar length between the third die location 50c and the negative terminal end 44b, the parasitic inductance of the fifth die location 50e is less than both the parasitic inductance of the first die location 50a and the third die location 50c. Furthermore, because a sixth bus bar length between the sixth die location 50f and the positive terminal end 44a is less than both the second bus bar length and a fourth bus bar length between the fourth die location 50d and the positive terminal end 44a, the parasitic inductance of the sixth die location 50f is less than both the parasitic inductance of the second die location 50b and the fourth die location 50d. After block 106, the method 100 proceeds to block 108.

At block 108, the plurality of electrical characteristics of each of the plurality of power switch dies 42 are determined. In an exemplary embodiment, the plurality of electrical characteristics includes at least one of: the threshold voltage and the material type. In a non-limiting example, the plurality of electrical characteristics are determined by electrical testing of each of the plurality of power switch dies 42 (e.g., measurement of voltage and current during switching and on-state current flow). In another non-limiting example, the plurality of electrical characteristics of each of the plurality of power switch dies 42 are provided by the manufacturer of each of the plurality of power switch dies 42. After block 108, the method 100 proceeds to block 110.

At block 110, the plurality of power switch dies 42 are affixed to the plurality of DC bus bars based at least in part on the parasitic inductance of each of the plurality of die locations to minimize the drain-source voltage overshoot of each of the plurality of power switch dies 42 during switching. In an exemplary embodiment, the one of the plurality of die locations for each of the plurality of power switch dies 42 is selected based at least in part on the parasitic inductance of each of the plurality of die locations determined at block 106 and the threshold voltage of each of the plurality of power switch dies 42 determined at block 108. Dies having a relatively higher threshold voltage are placed at die locations having a relatively higher parasitic inductance to balance the effects of switching speed and inductance on voltage overshoot such that the drain-source voltage overshoot of each of the plurality of power switch dies 42 is less than or equal to the predetermined voltage overshoot threshold. In another exemplary embodiment, dies having similar threshold voltages (i.e., within a predetermined range of each other, for example, ±5%) are grouped together to be affixed adjacent to one another and/or on the same power module to minimize voltage overshoot and/or current sharing mismatch due to switching mismatches. Furthermore, dies having similar on resistance are grouped together to be affixed adjacent to one another and/or on the same power module to minimize load current mismatch.

In a non-limiting example, for the embodiment shown in FIG. 3A, the first power switch die 42a is affixed at the first die location 50a. The first power switch die 42a has a first threshold voltage and the first die location 50a has a first parasitic inductance. The third power switch die 42c is affixed at the third die location 50c. The third power switch die 42c has a third threshold voltage and the third die location 50c has a third parasitic inductance. The third threshold voltage (i.e., the threshold voltage of the third power switch die 42c) is greater than the first threshold voltage (i.e., the threshold voltage of the first power switch die 42a) and the third parasitic inductance (i.e., the parasitic inductance of the third die location 50c) is greater than the first parasitic inductance (i.e., the parasitic inductance of the first die location 50a) as evidenced by the longer bus bar length for the third die location 50c as compared to the first die location 50a.

In a non-limiting example, for the embodiment shown in FIG. 3B, the fifth power switch die 42e is affixed at the fifth die location 50e. The fifth power switch die 42e has a fifth threshold voltage and the fifth die location 50e has a fifth parasitic inductance. The first power switch die 42a is affixed at the first die location 50a and the third power switch die 42c is affixed at the third die location 50c. The first power switch die 42a has a first threshold voltage and the first die location 50a has a first parasitic inductance. The third power switch die 42c has a third threshold voltage and the third die location 50c has a third parasitic inductance. The first threshold voltage and the third threshold voltage are greater than the fifth threshold voltage. The first parasitic inductance and the third parasitic inductance are greater than the fifth parasitic inductance as evidenced by the longer bus bar length for the first die location 50a and the third die location 50c as compared to the fifth die location 50e.

In another non-limiting example, for the embodiment shown in FIG. 3A, the first power switch die 42a is affixed at the first die location 50a. The first power switch die 42a has a first threshold voltage and the first die location 50a has a first parasitic inductance. The second power switch die 42b is affixed at the second die location 50b (i.e., the second power switch die 42b is affixed at one of the plurality of high-side die locations 48a). The second power switch die 42b has a second threshold voltage and the second die location 50b has a second parasitic inductance. The second threshold voltage (i.e., the threshold voltage of the second power switch die 42b) is greater than the first threshold voltage (i.e., the threshold voltage of the first power switch die 42a) and the second parasitic inductance (i.e., the parasitic inductance of the second die location 50b) is greater than the first parasitic inductance (i.e., the parasitic inductance of the first die location 50a) as evidenced by the longer bus bar length for the second die location 50b as compared to the first die location 50a.

In another exemplary embodiment, the one of the plurality of die locations for each of the plurality of power switch dies 42 is selected based at least in part on the parasitic inductance of each of the plurality of die locations determined at block 106 and the material type of each of the plurality of power switch dies 42 determined at block 108. In a non-limiting example, dies having a faster switching material type are placed at die locations having a relatively lower parasitic inductance to balance the effects of switching speed, reverse recovery, and inductance on voltage overshoot such that the drain-source voltage overshoot of each of the plurality of power switch dies 42 is less than or equal to the predetermined voltage overshoot threshold.

In a non-limiting example, for the embodiment shown in FIG. 3A, the third power switch die 42c is affixed at the third die location 50c. The third power switch die 42c has a first material type and the third die location 50c has a third parasitic inductance. The fourth power switch die 42d is affixed at the fourth die location 50d. The fourth power switch die 42d has a second material type and the fourth die location 50d has a fourth parasitic inductance. The second material type (i.e., the material of the fourth power switch die 42d) is silicon (Si). The first material type (i.e., the material type of the third power switch die 42c) is silicon carbide (SiC). The fourth parasitic inductance (i.e., the parasitic inductance of the fourth die location 50d) is greater than the third parasitic inductance (i.e., the parasitic inductance of the third die location 50c) as evidenced by the longer bus bar length for the fourth die location 50d as compared to the third die location 50c.

In a non-limiting example, for the embodiment shown in FIG. 3B, the fifth power switch die 42e is affixed at the fifth die location 50e. The fifth power switch die 42e has a fifth material type and the fifth die location 50e has a fifth parasitic inductance. The first power switch die 42a is affixed at the first die location 50a and the third power switch die 42c is affixed at the third die location 50c. The first power switch die 42a has a first material type and the first die location 50a has a first parasitic inductance. The third power switch die 42c has a third material type and the third die location 50c has a third parasitic inductance. The first material type and the third material type are both silicon (Si). The fifth material type is silicon carbide (SiC). The first parasitic inductance and the third parasitic inductance are greater than the fifth parasitic inductance as evidenced by the longer bus bar length for the first die location 50a and the third die location 50c as compared to the fifth die location 50e.

After selecting the one of the plurality of die locations for each of the plurality of power switch dies 42, the plurality of power switch dies 42 are affixed to the dielectric substrate 40. Electrical connections between the components are established using a plurality of conductors (e.g., busbars, bonding wires, bonding clips, bonding ribbons, and/or the like). Control terminals for connecting gate terminals (not shown) of each of the plurality of power switch dies 42 to gate drivers (not shown) and/or to the inverter controller (not shown) and/or to the controller 14 are realized as pins extending orthogonally from the dielectric substrate 40 and electrically connected to the gate terminals using bonding wires. After block 110, the method 100 proceeds to block 112.

At block 112, the first power module 32a is affixed to the heatsink 30. It should be understood that the method 100 may also include additional steps including, for example, electrical connection of components, testing of components, enclosure, encapsulation, or conformal coating of components, quality assurance, and/or the like. After block 112, the method 100 proceeds to enter a standby state at block 114.

In an exemplary embodiment, the method 100 is repeatedly restarted at block 102 to produce the plurality of power modules 32 (e.g., the second power module 32b and the third power module 32c) and affix each of the plurality of power modules 32 to the heatsink 30 to complete assembly of the power inverter 20.

The method 100 of the present disclosure offers several advantages. By manufacturing the power inverter 20 according to the method 100, voltage overshoot is mitigated, increasing performance, longevity, and reliability of the power inverter 20. The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A power inverter comprising:
a plurality of direct current (DC) bus bars, wherein each of the plurality of DC bus bars has a terminal end and a die attachment region; and
a plurality of power switch dies, wherein each of the plurality of power switch dies is affixed to the die attachment region at one of a plurality of die locations, wherein the one of the plurality of die locations for each of the plurality of power switch dies is selected to minimize a drain-source voltage overshoot of each of the plurality of power switch dies during switching.

2. The power inverter of claim 1, wherein the one of the plurality of die locations for each of the plurality of power switch dies is selected based at least in part on a parasitic inductance of each of the plurality of die locations, and wherein the parasitic inductance of each of the plurality of die locations is a parasitic inductance between each of the plurality of die locations and the terminal end of one of the plurality of DC bus bars.

3. The power inverter of claim 2, wherein the parasitic inductance of each of the plurality of die locations varies directly with a bus bar length between each of the plurality of die locations and the terminal end.

4. The power inverter of claim 2, wherein the one of the plurality of die locations for each of the plurality of power switch dies is selected based at least in part on a threshold voltage of each of the plurality of power switch dies.

5. The power inverter of claim 4, wherein:
a first power switch die of the plurality of power switch dies is affixed at a first die location of the plurality of die locations, wherein the first power switch die has a first threshold voltage and the first die location has a first parasitic inductance; and
a second power switch die of the plurality of power switch dies is affixed at a second die location of the plurality of die locations, wherein the second power switch die has a second threshold voltage and the second die location has a second parasitic inductance, and wherein the second threshold voltage is greater than the first threshold voltage and the second parasitic inductance is greater than the first parasitic inductance.

6. The power inverter of claim 5, wherein:
the plurality of DC bus bars includes:
a positive DC bus bar, wherein the positive DC bus bar has a positive terminal end and a positive die attachment region; and
a negative DC bus bar, wherein the negative DC bus bar has a negative terminal end and a negative die attachment region; and
the plurality of power switch dies includes:
a plurality of high-side power switch dies, wherein each of the plurality of high-side power switch dies is affixed to the positive die attachment region of the positive DC bus bar at one of a plurality of high-side die locations; and
a plurality of low-side power switch dies, wherein each of the plurality of low-side power switch dies is affixed to negative die attachment region of the negative DC bus bar at one of a plurality of low-side die locations.

7. The power inverter of claim 6, wherein the second die location is one of the plurality of high-side die locations.

8. The power inverter of claim 2, wherein the one of the plurality of die locations for each of the plurality of power switch dies is selected based at least in part on a material type of each of the plurality of power switch dies.

9. The power inverter of claim 8, wherein:
a third power switch die of the plurality of power switch dies is affixed at a first die location of the plurality of die locations, wherein the third power switch die has a first material type and the first die location has a first parasitic inductance; and
a fourth power switch die of the plurality of power switch dies is affixed at a second die location of the plurality of die locations, wherein the fourth power switch die has a second material type and the second die location has a second parasitic inductance, and wherein the second parasitic inductance is greater than the first parasitic inductance.

10. The power inverter of claim 9, wherein the first material type is silicon carbide and the second material type is silicon.

11. A method for manufacturing a power inverter, the method comprising:
affixing a plurality of direct current (DC) bus bars to a dielectric substrate, wherein each of the plurality of DC bus bars has a terminal end and a die attachment region; and
affixing a plurality of power switch dies to the plurality of DC bus bars, wherein each of the plurality of power switch dies is affixed to the die attachment region at one of a plurality of die locations, wherein the one of the plurality of die locations for each of the plurality of power switch dies is selected to minimize a drain-source voltage overshoot of each of the plurality of power switch dies during switching.

12. The method of claim 11, wherein affixing the plurality of power switch dies further comprises:
selecting the one of the plurality of die locations for each of the plurality of power switch dies based at least in part on a parasitic inductance of each of the plurality of die locations, wherein the parasitic inductance of each of the plurality of die locations is a parasitic inductance between each of the plurality of die locations and the terminal end of one of the plurality of DC bus bars.

13. The method of claim 12, wherein selecting the one of the plurality of die locations for each of the plurality of power switch dies further comprises:
selecting the one of the plurality of die locations for each of the plurality of power switch dies based at least in part on a threshold voltage of each of the plurality of power switch dies.

14. The method of claim 13, wherein affixing the plurality of power switch dies further comprises:
affixing a first power switch die of the plurality of power switch dies at a first die location of the plurality of die locations, wherein the first power switch die has a first threshold voltage and the first die location has a first parasitic inductance; and
affixing a second power switch die of the plurality of power switch dies at a second die location of the plurality of die locations, wherein the second power switch die has a second threshold voltage and the second die location has a second parasitic inductance, and wherein the second threshold voltage is greater than the first threshold voltage and the second parasitic inductance is greater than the first parasitic inductance.

15. The method of claim 14, wherein:
affixing the plurality of DC bus bars further comprises:
affixing a positive DC bus bar to the dielectric substrate, wherein the positive DC bus bar has a positive terminal end and a positive die attachment region, and wherein the positive terminal end is in electrical communication with a DC positive terminal; and
affixing the plurality of power switch dies further comprises:
affixing a plurality of high-side power switch dies to the positive die attachment region of the positive DC bus bar at one of a plurality of high-side die locations, wherein the second die location is one of the plurality of high-side die locations.

16. The method of claim 12, wherein selecting the one of the plurality of die locations for each of the plurality of power switch dies further comprises:
selecting the one of the plurality of die locations for each of the plurality of power switch dies based at least in part on a material type of each of the plurality of power switch dies.

17. The method of claim 16, wherein affixing the plurality of power switch dies further comprises:
affixing a third power switch die of the plurality of power switch dies at a first die location of the plurality of die locations, wherein the third power switch die has a silicon carbide material type and the first die location has a first parasitic inductance; and
affixing a fourth power switch die of the plurality of power switch dies at a second die location of the plurality of die locations, wherein the fourth power switch die has a silicon material type and the second die location has a second parasitic inductance, and wherein the second parasitic inductance is greater than the first parasitic inductance.

18. A power inverter for a vehicle, the power inverter comprising:
a plurality of direct current (DC) bus bars, wherein each of the plurality of DC bus bars has a terminal end and a die attachment region; and
a plurality of power switch dies, wherein each of the plurality of power switch dies is affixed to the die attachment region at one of a plurality of die locations, wherein the one of the plurality of die locations for each of the plurality of power switch dies is selected to minimize a drain-source voltage overshoot of each of the plurality of power switch dies during switching, wherein the one of the plurality of die locations for each of the plurality of power switch dies is selected based at least in part on a parasitic inductance of each of the plurality of die locations, and wherein the parasitic inductance of each of the plurality of die locations is a parasitic inductance between each of the plurality of die locations and the terminal end of one of the plurality of DC bus bars.

19. The power inverter of claim 18, wherein:
a first power switch die of the plurality of power switch dies is affixed at a first die location of the plurality of die locations, wherein the first power switch die has a first threshold voltage and the first die location has a first parasitic inductance; and
a second power switch die of the plurality of power switch dies is affixed at a second die location of the plurality of die locations, wherein the second power switch die has a second threshold voltage and the second die location has a second parasitic inductance, and wherein the second threshold voltage is greater than the first threshold voltage and the second parasitic inductance is greater than the first parasitic inductance.

20. The power inverter of claim 18, wherein:
a third power switch die of the plurality of power switch dies is affixed at a first die location of the plurality of die locations, wherein the third power switch die has a first material type and the first die location has a first parasitic inductance; and
a fourth power switch die of the plurality of power switch dies is affixed at a second die location of the plurality of die locations, wherein the fourth power switch die has a second material type and the second die location has a second parasitic inductance, and wherein the second parasitic inductance is greater than the first parasitic inductance.
